(19) United States
(12) Patent Application Publication
(10) Pub. No.: US 2010/0278124 A1
(43) Pub. Date: Nov. 4, 2010

(54) ADAPTIVE BEACON COORDINATION IN COMMUNICATION NETWORK USING SIGNAL FORMATS

(75) Inventors: Lei Huang, Singapore (SG); Hong Cheng Michael Sim, Singapore (SG); Zhan Yu, Singapore (SG); Taisuke Matsumoto, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/524,456

(22) PCT Filed: Jan. 23, 2008
(86) PCT No.: PCT/JP2008/050887

§ 371 Date: Jul. 31, 2009

(30) Foreign Application Priority Data
Jan. 26, 2007 (JP) 2007-015780

(51) Int. Cl. H04W 40/00; H04W 72/12

(52) U.S. Cl. 370/329; 370/328

(57) ABSTRACT

An adaptive beacon coordination method in a communication network using signal formats mutually incompatible. A coordination device broadcasts a first beacon in a first signal format and a second beacon in a second signal format in a superframe. The first and second beacons are used to send medium access information to a client device having the first signal format and a client device having the second signal format, respectively. When there are three or more signal formats in a network, the coordination device can broadcast three or more beacons. The number of beacons can be adapted to various superframes according to the functions of all the client devices in the network. If all the client devices support a signal format, the coordination device broadcasts only a single beacon in the signal format. After a predetermined number of superframes, the coordination device again starts to broadcast beacons so that new client devices having different respective signal formats can join the network.

### TECHNICAL FIELD

The present invention generally relates to beacon coordination in wireless communication networks. To be more specific, the present invention relates to adaptive beacon coordination in a centralized communication network adopting multiple signal formats which are not all compatible with each other.

### BACKGROUND ART

In wireless communication networks, multiple apparatuses communicate with each other via a wireless medium. Such wireless medium should be accessed according to a medium access schedule in order to prevent signal collisions in which multiple signals are received by the same receiving apparatus simultaneously. Wireless medium access can be coordinated by either a single apparatus or multiple apparatuses. In a centralized network, one apparatus serves as a central coordinator to coordinate wireless medium access for all apparatuses in the network. In a distributed network, there is no central coordinator, and instead, all apparatuses share the task of coordination by exchanging coordination information with each other and realize a wireless medium access schedule.

The Institute of Electrical and Electronic Engineers (“IEEE”) has adopted a centralized medium access coordination mechanism in the 802.15.3™-2003 standard for high rate wireless personal area networks (“WPANs”), which defines both the medium access control (“MAC”) layer and the physical (“PHY”) layer. FIG. 1 is a schematic diagram illustrating IEEE 802.15.3 wireless network 100, which includes three client apparatuses 102a, 102b and 102c, and central coordination apparatus 104, which is called the “piconet controller” (“PNC”). All the apparatuses share the same frequency band for signal transmission in network 100. PNC 104 broadcasts a beacon (represented by dashed line 108) to all the client apparatuses in the network at the beginning of each superframe. Since the beacon contains information as to when and how to access the medium, all client apparatuses must be able to decode the beacon signal.

In the IEEE 802.15.3™-2003 standard, a beacon signal is broadcasted by the PNC in a common signal format that is supported by all apparatuses. However, such a beacon coordination mechanism is invalid if there is no common signal format. This is because a client apparatus is not able to decode a beacon signal if the client apparatus adopts a signal format that is incompatible with the beacon signal format. This could occur in unlicensed radio frequency bands, where a large number of disparate radio apparatuses adopting different signal formats use the same frequency band.

Hence, there is a need to design a beacon coordination mechanism in a centralized communication network adopting multiple signal formats that are incompatible with each other.

### DISCLOSURE OF INVENTION

### Problems to be Solved by the Invention

In a centralized communication network adopting multiple signal formats, a client apparatus is not able to decode a single beacon signal from the PNC if the signal formats of the client apparatus and the signal format of the beacon are incompatible. In other words, using a single beacon, it is not possible to coordinate wireless medium access in a centralized network adopting multiple signal formats that are incompatible with each other.

In U.S. Patent Application Publication No. 2005/0174964, “Coordinating communications in a heterogeneous communications network using different signal formats,” a two-beacon coordination method is proposed by transmitting the first beacon in the first signal format at the beginning of each superframe and transmitting the second beacon in the second signal format in the contention free period (“CFP”). Two-beacon transmission allows client apparatuses adopting different signal formats to decode at least one of the first and second beacon signals. The superframe structure in conventional techniques is shown in FIG. 2. Superframe 220 is comprised of beacon 222 in format A, contention access period (“CAP”) 223 and CFP 224. CFP 224 is divided into multiple time slots 226, and at least one time slot 228 is occupied by a copy of the beacon in format B. All apparatuses of format A wake up at the beginnings of superframes and decode the beacons in format A (222 and 232 in the figure). Further, all apparatuses of format B wake up at the beginning of a particular CFP time slot and decode the beacons in format B (228 and 238 in the figure). Time difference between two consecutive beacons in format B is usually equal to the superframe duration.

However, this conventional technique may cause difficulties in the implementation. One difficulty is that an apparatus of format A and an apparatus of format B may have different perspectives on the superframe structure. From the viewpoint of a client apparatus of format A, a superframe is comprised of a beacon with format A, a CAP and a CFP, in sequence, and meets the IEEE 802.15.3™-2003 standard. On the other hand, from the viewpoint of a client apparatus of format B, a superframe is comprised of a beacon with format B, the first CFP, a CAP and a second CFP, in sequence, and does not meet the IEEE 802.15.3™-2003 standard. Since a beacon contains medium access information about the CAP and CFP, the first and second beacons have different formats and information.

In addition, no beacon transmission investigated in the conventional technique is adaptive. For example, if all client apparatuses adopting format A leave the network, it is sufficient to coordinate medium access in the communication network by only transmitting a single beacon with format B. In such a case, the two-beacon transmission mechanism in the conventional technique would lower MAC efficiency.

### Means for Solving the Problem

With the present invention, an adaptive beacon coordination method is proposed for a centralized communication network adopting multiple signal formats that are incompatible with each other. When a network starts, the PNC broadcasts multiple beacons at the beginning of the first superframe. Each beacon is transmitted in a different signal format so that client apparatuses adopting different signal formats are able to join the network. In an ensured superframe, the number of beacons transmitted depends on PHY capabilities of all the client apparatuses in the network. For example, if all the client apparatuses in the network adopt the same signal format, a single beacon is transmitted by the PNC in that signal format. In the case of single beacon transmission, the PNC is also designed to resume multiple beacon transmission after a predetermined number of superframes to allow new client apparatuses adopting different signal formats to join the network.

According to the first aspect of the present invention, a method of coordinating medium access is provided in a communication network comprised of a plurality of apparatuses. The method includes: broadcasting a first beacon in a first signal format and a second beacon in a second signal format in a superframe, in which the first beacon and the second beacon contain medium access information and are incompatible with each other; gathering information about the signal formats supported by a plurality of apparatuses in the communication network; and determining the number of beacons required in the communication network based on the gathered information about the signal formats and broadcasting beacons of the determined number in the following superframes.

The method further includes determining a single beacon in one of the first and second signal formats and broadcasting the determined single beacon in each of a predetermined number of following superframes, when there is a signal format supported by all of the plurality of apparatuses.

The method further includes determining two beacons required in the communication network and broadcasting the fist beacon in the first signal format and the second beacon in the second signal format in the following superframe, when there is no a signal format supported by all of the plurality of apparatuses.

When all of the plurality of apparatuses support the first signal format or all the plurality of apparatuses support the second signal format, the method further includes: gathering information about the signal formats supported by each of the plurality of apparatuses in the network in each of the predetermined number of following superframes; and broadcasting the first beacon in the first signal format and the second beacon in the second signal format after the predetermined number of following superframes.

When all the plurality of apparatuses support the second signal format, the method further includes: gathering information about the signal formats supported by each of plurality of apparatuses in the network in each of the predetermined number of following superframes; and broadcasting the first beacon in the second signal format and the second beacon in the first signal format after the predetermined number of following superframes.

According to the second aspect of the present invention, a communication network is provided. The communication network includes: a first group of apparatuses communicating in a first signal format; a second group of apparatuses communicating in a second signal format; and a coordinator including: broadcasting a first beacon in a first signal format and a second beacon in a second signal format in a superframe; gathering, from the first and second groups of apparatuses, information about the signal formats supported by the first and second apparatuses; and determining the number of beacons required in the communication network based on the gathered information about the signal formats and broadcasting the beacons of the determined number of beacons in the following superframes.

### Advantageous Effects of Invention

By using the present invention, each client apparatus can capture the corresponding beacon by using its own signal format. Further, there is no common signal format that is required by all client apparatuses in the network. Further, the number of beacons transmitted in a superframe is also adaptive according to the PHY capabilities of all client apparatuses in the network. Thus, beacon transmission is more efficient than in the conventional technique. Furthermore, since all beacons are transmitted together at the beginning of a superframe, the superframe structure is identical between all client apparatuses adopting different signal formats and meets the IEEE 802.15.3™-2003 standard. The frame formats of all beacons are also the same.

### BRIEF DESCRIPTION OF DRAWINGS

FIG. 1 illustrates an exemplary network structure in IEEE 802.15.3;

FIG. 2 illustrates an exemplary superframe structure for two-beacon transmission in the conventional technique;

FIG. 3 illustrates exemplary flowchart 300 according Embodiment 1 of the present invention;

FIG. 4 illustrates the exemplary superframe structure according to Embodiment 1;

FIG. 5 illustrates exemplary flowchart 500 according to Embodiment 2 of the present invention; and FIG. 6 illustrates the exemplary superframe structure according to Embodiment 2.

### BEST MODE FOR CARRYING OUT THE INVENTION

In the following paragraphs, the present invention will be described in detail using embodiments, with reference to the accompanying drawings. Although the present invention is capable of embodiment in many different forms, specific embodiments will be described in detail using the drawings, with the understanding that the present disclosure is to be considered as an example of the principles of the invention and is not intended to limit the present invention to the specific embodiments shown and described. That is, the embodiments and illustrations shown below should be considered as examples, rather than as limitations on the present invention. As used herein, “the present invention” refers to any embodiment of the invention described herein and any equivalent. Furthermore, note that reference to various features of “the present invention” throughout this document does not mean that all claimed embodiments or methods include the referenced features.

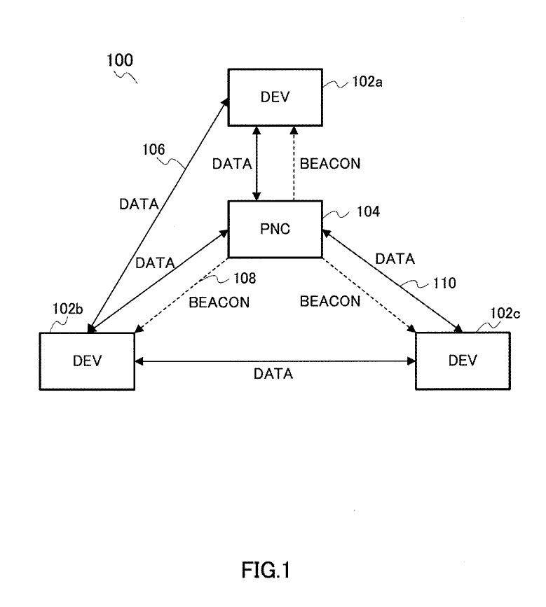

According to the present invention, client apparatuses 102a, 102b and 102c in FIG. 1 can use two different signal formats that are incompatible with each other. Each client apparatus may support only one or both of these signal formats. For example, in FIG. 1, apparatus 102a only supports signal format A, apparatus 102c only supports signal format B, and apparatus 102b supports both signal formats A and B. Data communication can occur between two client apparatuses adopting the same signal format, like link 106 supporting signal format A. However, due to different signal formats, not all client apparatuses can communicate with each other, like client apparatuses 102a and 102c. PNC 104 should support both signal formats A and B, and can communicate with all client apparatuses in the network 100 by using one of two different signal formats, like link 110 supporting signal format B.

In the present invention, PNC 104 makes use of an adaptive beacon coordination mechanism to coordinate medium access in network 100. When network 100 starts, PNC 104 broadcasts two beacons at the beginning of the first superframe (see link 108 represented by the dashed line). Each beacon may contain information about network parameters, CAP start, CAP duration, CFP schedule as well as other management information. Each beacon is transmitted in a different signal format so that client apparatuses adopting different signal formats are able to join network 100. In a following superframe, the number of beacons transmitted depends on the PHY capabilities of all client apparatuses in network 100. For example, if all client apparatuses in network 100 adopt the same signal format, only a single beacon is transmitted by PNC 104 in that signal format. In the case of single beacon transmission, PNC 104 is also designed to resume two-beacon transmission after a predetermined number of superframes, to allow new client apparatuses adopting different signal formats to join network 100.

### Embodiment 1

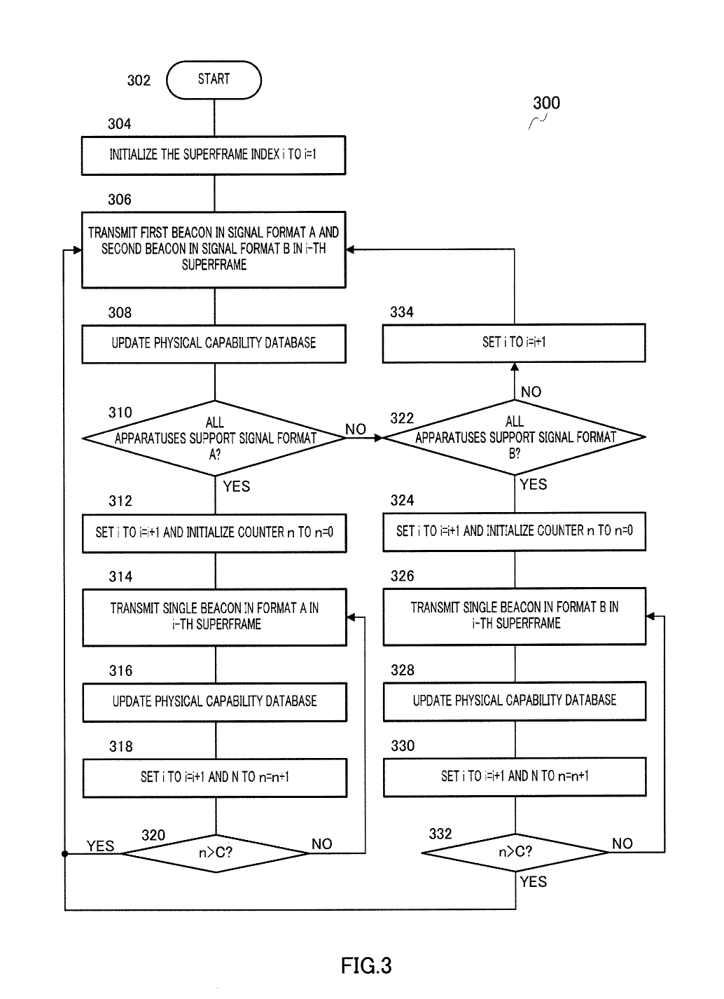

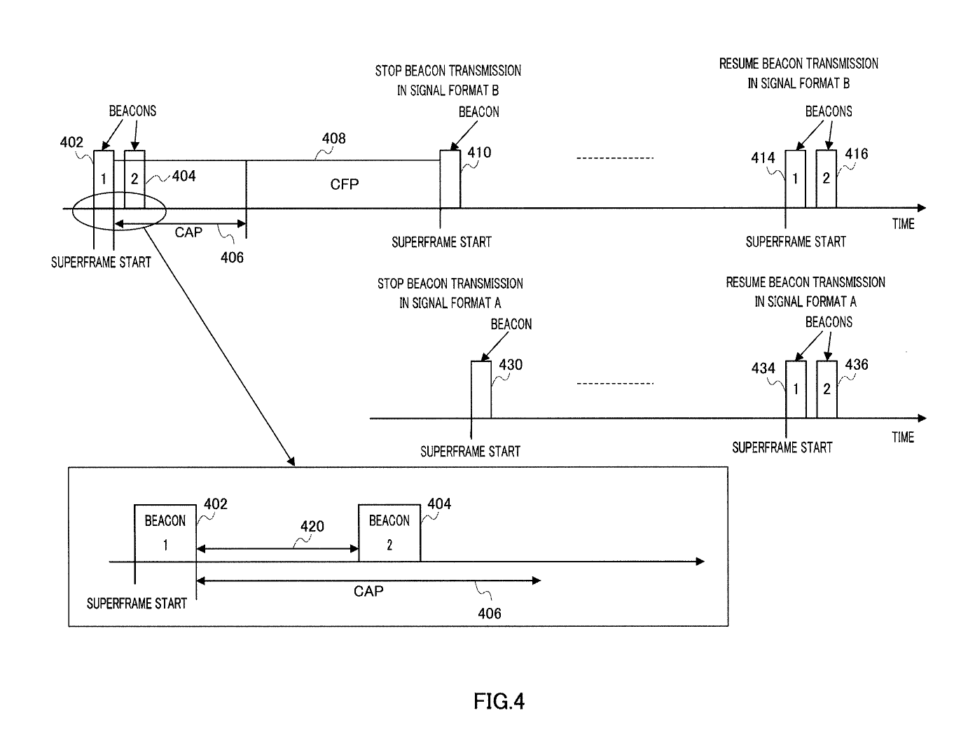

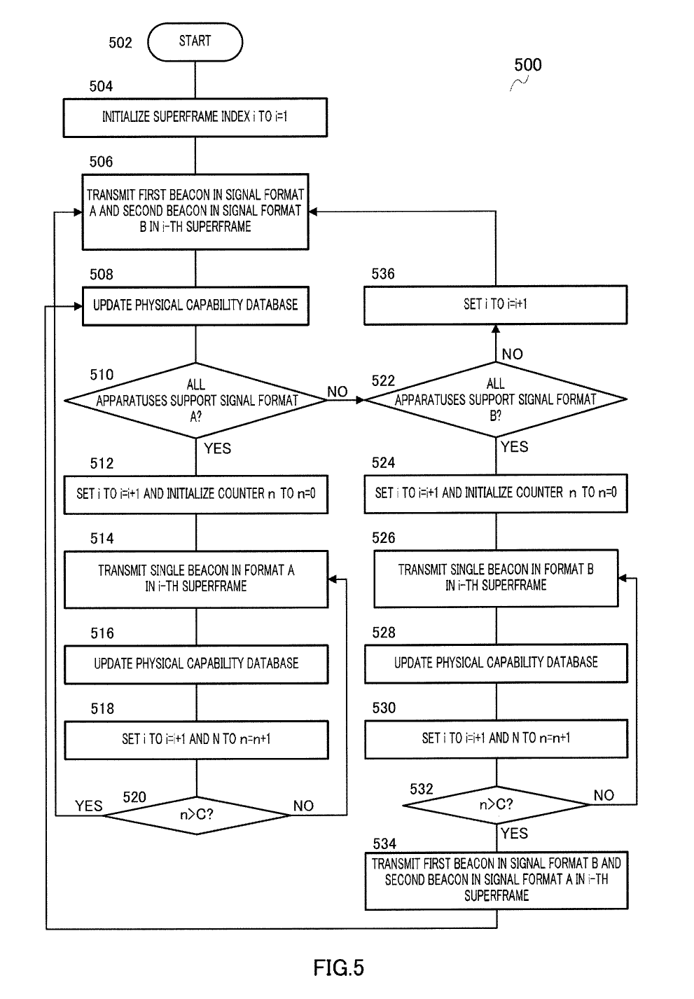

FIG. 3 illustrates exemplary flowchart 300 according to Embodiment 1 of the present invention. FIG. 4 is a schematic diagram illustrating the superframe structure according to Embodiment 1. The processing operations in exemplary flowchart 300 will be described below with reference to FIG. 1 and FIG. 4.

In step 302, the processing operations in exemplary flowchart 300 start. PNC 104 performs step 304 to initialize a superframe index i to i=1. In step 306, PNC 104 starts a network by broadcasting first beacon 402 in signal format A and second beacon 404 in signal format B in the i-th superframe.

As shown in FIG. 4, second beacon 404 is sent in CAP 406. Time offset 420 of second beacon 404 with respect to the start of CAP should be less than a predetermined value to prevent all client apparatuses from accessing CAP 406 before second beacon transmission. This predetermined value should be set to the amount of time a client apparatus takes to sense the channel. For example, this predetermined value is defined as the pBackoffSlot parameter in the IEEE 802.15.3™-2003 standard. Furthermore, since first beacon 402 and second beacon 304 are sent in different signal formats, time offset 420 should also be larger than the permissible switch time in a transceiver.

A client apparatus adopting signal format A is able to decode first beacon 402 but is not able to decode second beacon 404 that is sent in CAP 406. On the other hand, a client apparatus adopting signal format B is not able to decode the first beacon 402 but is able to decode second beacon 404. Hence, the client apparatus adopting signal format B has a different perspective on the duration of the CAP from the client apparatus adopting signal format A. In other words, information about the duration of CAP included in second beacon 404 should not be the same as that in first beacon 402.

In step 308, PNC 104 maintains a PHY capability database containing information about the supported signal format for each client apparatus present in network 100. To update the PHY capability database, PNC 104 must know the signal formats supported by the client apparatuses that join network 100. Furthermore, PNC 104 must also know whether an associated client apparatus is still present in network 100.

According to the IEEE

802.15.3™-2003 standard, there are various ways to obtain PHY capability information for client apparatuses that join network 100. An association request command, which includes the data rate field and reserved field supported under the DEV capabilities field, may be used by a client apparatus such as client apparatus 102a, to join network 100. Either the supported data rate field or reserved filed within the association request command may be used by PNC 104 to determine the signal formats supported by client apparatus 102a that joins network 100.

The data rates that can be used in client apparatus 102a indicate the supported signal formats. PNC 104 can determine the signal formats supported by client apparatus 102a, by checking the supported data rate field from the association request command sent by client apparatus 102a. For example, in the IEEE 802.15.3™-2003 standard, the binary sequence “01000” in the supported data rate field means that three different data rates of 11 Mb/s, 22 Mb/s and 33 Mb/s are supported. From these three supported data rates, it can be found that three different signal formats of QPSK, DQPSK and 16QAM are supported.

Alternatively, a new supported signal format field may be defined under the reserved field. PNC 104 can determine the signal formats supported by client apparatus 102a by directly checking the supported signal format field from the association request command sent by client apparatus 102a.

In accordance with the IEEE 802.15.3™-2003 standard, there exist various ways of determining whether an associated client apparatus is still present in network 100. As one way, a client apparatus, e.g., client apparatus 102c, which is going to end its membership in network 100, sends a disassociation request command to PNC 104. If PNC 104 receives the disassociation request command from client apparatus 102c, PNC 104 can determine that client apparatus 102c will not be present in network 100.

However, client apparatus 102c may not send the disassociation request command to PNC 104 before client apparatus 102c leaves network 100. In this case, another way may be used by PNC 104 to determine whether client apparatus 102c is still present in network 100. In accordance with the IEEE 802.15.3™-2003 standard, client apparatus 102c shall send frames to PNC 104 often enough to assure that the association timeout period (“ATP”) is not reached. If PNC 104 does not receive any frame originating from client apparatus 102c within this timeout period, PNC 104 can determine that client apparatus 102c will not be present in network 100.

Alternatively, before the ATP expires, PNC 104 may send a probe request command with the information requested field set to zero and ACK policy field set to Imm-ACK to client apparatus 102c, to determine if client apparatus 102c is still present in network 100.

After updating the PHY capability database, in step 310, PNC 104 determines whether all client apparatuses support signal format A according to the information in the PHY capability database. If all client apparatuses support signal format A, PNC 104 performs step 312 to increment the superframe index i and initialize a counter n to n=0. In step 314, PNC 104 transmits only single beacon 410 in signal format A in the i-th superframe.

In step 316, PNC 104 updates the PHY capability database in a similar manner to step 308. After that, PNC 104 performs step 318 to increment the superframe index i and increment the counter n. In step 320, if the value of the counter n is lower than a predetermined value C, the processing operation in exemplary flowchart 300 loops back to step 314. Otherwise, the processing operation in exemplary flowchart 300 loops back to step 306 to transmit first beacon 414 in signal format A and second beacon 416 in signal format B in the i-th superframe.

As shown in step 314 to step 320, if all client apparatuses support signal format A, only a single beacon is transmitted in signal format A in each of C consecutive superframes for the purpose of improving MAC efficiency. However, after single beacon transmission for C consecutive superframes, a second beacon resumes being transmitted in signal format B to allow a new client apparatus with signal format B to join network 100, or to allow a network, in which the members adopt signal format B, to join network 100 as a child network.

The predetermined value C depends on the permissible waiting time of a specific application as well as the duration of the superframes. Here, this value may be determined by dividing the permissible waiting time of the specific application by the duration of the superframes. In step 310, if not all client apparatuses support signal format A, PNC 104 performs step 322 to determine whether all client apparatuses support signal format B according to the information in the PHY capability database.

In step 322, if all client apparatuses support signal format B, PNC 104 performs step 324 to increment the superframe index i and initialize the counter n to n=0. In step 326, PNC 104 transmits single beacon 430 in signal format B in the i-th superframe. The time period previously occupied by first beacon 430 is reserved by PNC 104 or is allocated to the client apparatuses for use.

In step 328, PNC 104 updates the PHY capability database in a similar manner to step 308. After that, PNC 104 performs step 330 to increment the superframe index i and increment the counter n. In step 332, if the value of the counter n is lower than the predetermined value C, the processing operation in exemplary flowchart 300 loops back to step 326. Otherwise, the processing operation in exemplary flowchart 300 loops back to step 306 to transmit first beacon 434 in signal format A and second beacon 436 in signal format B in the i-th superframe.

In step 322, if not all client apparatuses support signal format B, PNC 104 performs step 334 to increment the superframe index i, and the processing operation in exemplary flowchart 300 loops back to step 306.

### Embodiment 2

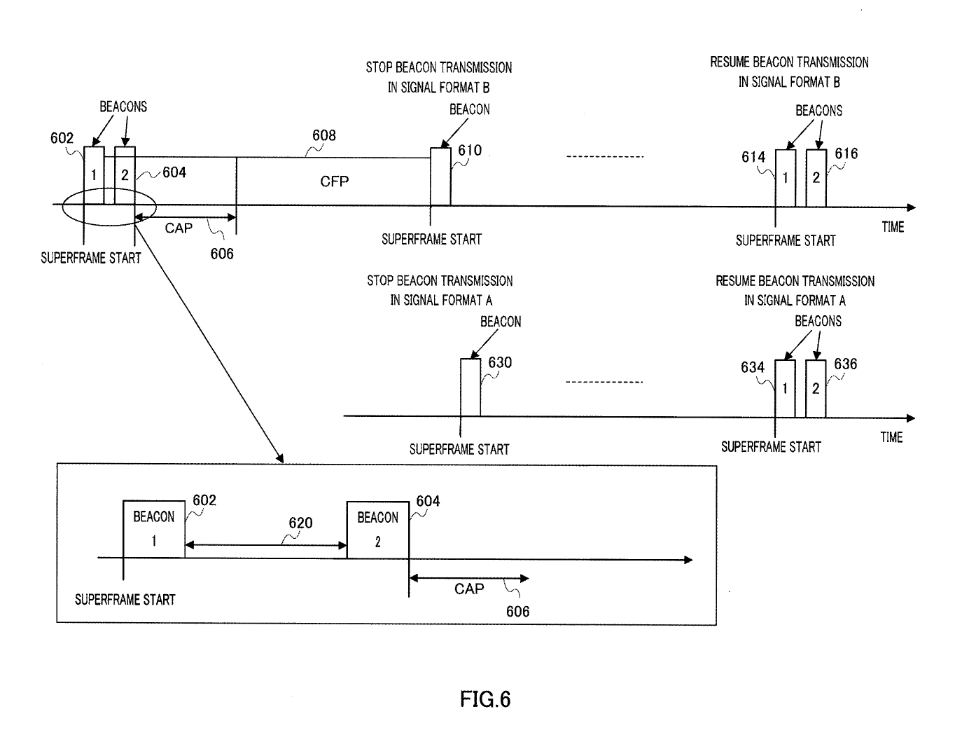

FIG. 5 illustrates exemplary flowchart 500 according to Embodiment 2 of the present invention. FIG. 6 is a schematic diagram illustrating the superframe structure according to Embodiment 2. The processing operations in exemplary flowchart 500 will be described below with reference to FIG. 1 and FIG. 6.

In step 502, the processing operation in exemplary flowchart 500 starts. PNC 104 performs step 504 to initialize a superframe index i to i=1. In step 506, PNC 104 starts a network by broadcasting first beacon 602 in signal format A and second beacon 604 in signal format B in the i-th superframe.

As shown in FIG. 5, both first beacon 602 and second beacon 604 are sent before CAP 606. This is different from Embodiment 1 shown in FIG. 3 and FIG. 4. Since first beacon 602 and second beacon 604 are sent in different signal formats, time offset 620 should be larger than the permissible switch time in a transceiver.

A client apparatus adopting signal format A is able to decode first beacon 602 but is not able to decode second beacon 604 that is also sent before CAP 606. On the other hand, a client apparatus adopting signal format B is not able to decode first beacon 602 but is able to decode second beacon 604. Hence, the client apparatus adopting signal format B has a different perspective on the start of CAP 606 from the client apparatus adopting signal format A. In other words, information about the start of CAP 606 included in second beacon 604 should be different from that in first beacon 602.

In step 508, PNC 104 maintains a PHY capability database in a similar manner to step 308 shown in FIG. 3. After updating the PHY capability database, in step 510, PNC 104 determines whether all client apparatuses support signal format A according to the information in the PHY capability database. If all client apparatuses support signal format A, PNC 104 performs step 512 to increment the superframe index i and initialize a counter n to n=0. In step 514, PNC 104 transmits only single beacon 610 in signal format A in the i-th superframe. The time period previously occupied by the second beacon is released to the CAP.

In step 516, PNC 104 updates the PHY capability database in a similar manner to step 308. After that, PNC 104 performs step 518 to increment the superframe index i and increment the counter n. In step 520, if the value of the counter n is lower than the predetermined value C, the processing operation in exemplary flowchart 500 loops back to step 514. Otherwise, the processing operation in exemplary flowchart 500 loops back to step 506 to transmit first beacon 614 in signal format A and second beacon 616 in signal format B in the i-th superframe.

In step 510, if not all client apparatuses support signal format A, PNC 104 performs step 522 to determine whether all client apparatuses support signal format B according to the information in the PHY capability database. If all client apparatuses support signal format B, PNC 104 performs step 524 to increment the superframe index i and initialize the counter n to n=0. In step 526, PNC 104 transmits single beacon 630 in signal format B in the i-th superframe. The time period previously occupied by the first beacon is reserved by PNC 104 or is allocated to the client apparatuses for use.

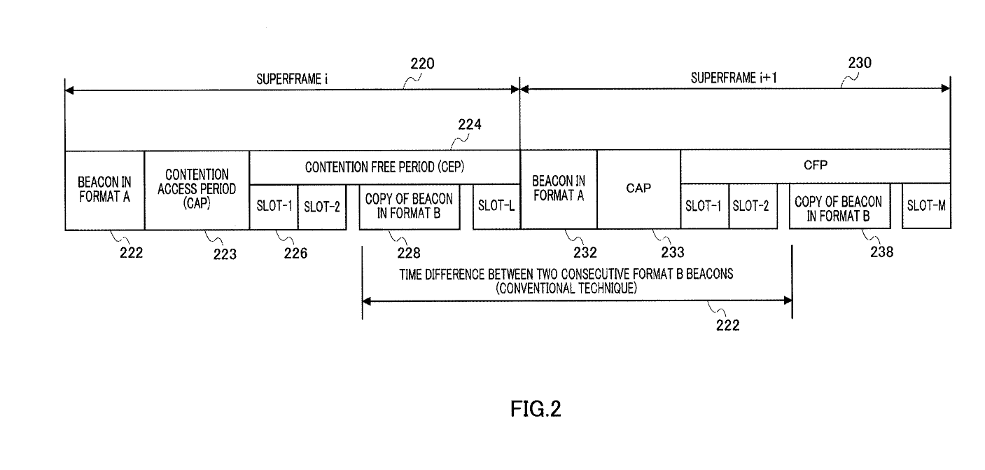

In step 528, PNC 104 updates the PHY capability database in a similar manner to step 308 shown in FIG. 2. After that, PNC 104 performs step 530 to increment the superframe index i and increment the counter n. In step 532, if the value of the counter n is lower than the predetermined value C, the processing operation in exemplary flowchart 500 loops back to step 526. Otherwise, PNC 104 performs step 534 to transmit first beacon 634 in signal format B and second beacon 636 in signal format A in the i-th superframe, and the processing operation in exemplary flowchart 500 loops back to step 508.

Similar to Embodiment 1 shown in FIG. 3 (see step 326 to step 332 and step 306), in Embodiment 2 (see step 526 to step 534), after transmitting a single beacon in signal format B in each of C consecutive superframes, PNC 104 resumes two-beacon transmission in two different signal formats to allow a new client apparatus with signal format A to join network 100. However, it should be noted that the way of transmitting two beacons is different between Embodiment 1 and Embodiment 2. In Embodiment 1 (see step 306), PNC 104 transmits first beacon 434 in signal format A and second beacon 436 in signal format B. On the other hand, in Embodiment 2 (see step 534), PNC 104 transmits first beacon 634 in signal format B and second beacon 636 in signal format A.

In step 522, if not all client apparatuses support signal format B, PNC 104 performs step 536 to increment the superframe index i, and the processing operation in exemplary flowchart 500 loops back to step 506.

In Embodiments 1 and 2 shown in FIG. 3 and FIG. 5, PNC 104 can broadcast not more than two beacons in a superframe. Note that a person skilled in the art naturally understands that the PNC can broadcast more than three beacons that are broadcasted in respective signal formats, if more than three signal formats are involved in network 100.

Note also that some or all of the figures are schematic representations for purposes of illustration and do not necessarily depict the actual relative sizes or locations of the elements shown. The figures are provided for the purpose of illustrating one or more embodiments of the present invention with the explicit understanding that these figures will not be used to limit the scope or the meaning of the claims.

Note that the present invention is not limited to the particular embodiments and that modifications may be made by persons skilled in the art. The scope of the invention is determined by the following claims, and any and all modifications that fall within that scope are intended to be included therein.

The disclosure of Japanese Patent Application No. 2007-015780, filed on Jan. 26, 2007, including the specification, drawings and abstract, is incorporated herein by reference in its entirety.

1. A method of coordinating medium access in a communication network comprising a plurality of apparatuses, the method comprising:
broadcasting a first beacon in a first signal format and a second beacon in a second signal format in a superframe, the first beacon and the second beacon containing medium access information;
gathering information about signal formats supported by a plurality of apparatuses in the communication network; and
determining the number of kinds of beacons required in the communication network based on the gathered information about the signal formats and broadcasting beacons of the determined number of kinds in following superframes.

2. The method according to claim 1, wherein the first signal format is incompatible with the second signal format.

3. The method according to claim 1, wherein the medium access information contains a start and/or a duration of a contention access period, and a schedule of a contention free period.

4. The method according to claim 1, wherein the second beacon is broadcasted in a contention access period and the first beacon is broadcasted before the contention access period.

5. The method according to claim 1, wherein the second beacon is broadcasted before a contention access period and the first beacon is broadcasted before the second beacon.

6. The method according to claim 1, wherein broadcasting beacons of the determined number of kinds in following superframes.comprises one of:
when there is a signal format supported by all of the plurality of apparatuses, determining a single beacon in one of the first and second signal formats and broadcasting the determined single beacon in each of a predetermined number of following superframes; and
when there is no signal format supported by all of the plurality of apparatuses, determining two beacons required in the communication network and broadcasting the fist beacon in the first signal format and the second beacon in the second signal format in the following superframes.

7. The method according to claim 6, further comprising determining the single beacon in the first signal format when all of the plurality of apparatuses support the first signal format.

8. The method according to claim 7, further comprising:
gathering information about the signal formats supported by each of the plurality of apparatuses in the communication network in each of the predetermined number of following superframes; and
broadcasting the first beacon in the first signal format and the second beacon in the second signal format after the predetermined number of following superframes.

9. The method according to claim 6, further comprising determining the single beacon in the second signal format when all of the plurality of apparatuses support the second signal format.

10. The method according to claim 9, further comprising:
gathering information about the signal formats supported by each of the plurality of apparatuses in the communication network in each of the predetermined number of following superframes; and
broadcasting the first beacon in the first signal format and the second beacon in the second signal format after the predetermined number of following superframes.

11. The method according to claim 9, further comprising:
gathering information about the signal formats supported by each of the plurality of apparatuses in the communication network in each of the predetermined number of following superframes; and
broadcasting the first beacon in the second signal format and the second beacon in the first signal format after the predetermined number of following superframes.

12. A communication network, comprising:
a) a first group of apparatuses communicating in a first signal format;
b) a second group of apparatuses communicating in a second signal format; and
c) a coordinator comprising:
broadcasting a first beacon in a first signal format and a second beacon in a second signal format in a superframe;
gathering, from the first and second groups of apparatuses, information about signal formats supported by the first and second groups; and
determining the number of kinds of beacons required in the communication network based on the gathered information about the signal formats, and broadcasting beacons of the determined number of kinds in following superframes.
